(19) United States
(12) Patent Application Publication
(10) Pub. No.: US 2012/0130677 A1
(43) Pub. Date: May 24, 2012

(54) INSPECTION SYSTEM FOR PLASTIC CONTAINERS

(76) Inventors: Georg V. Wolfe, Butler, PA (US); William E. Schmidt, Gibsonia, PA (US)

(21) Appl. No.: 13/299,949

(22) Filed: Nov. 18, 2011

Related U.S. Application Data
(60) Provisional application No. 61/415,645, filed on Nov. 19, 2010.

(51) Int. Cl. G01G 19/00

(52) U.S. Cl. 702/173

(57) ABSTRACT

Various embodiments are directed to systems and methods for generating section weights for blow-molded containers on-line. An inspection device may take a plurality of measurements of one or more container characteristics across a profile of a container while the container is on-line. A programmable processor may be programmed to receive the plurality of measurements and derive a material distribution of the container based on the plurality of measurements. The programmable processor may additionally be programmed to derive a relationship between the measured material distribution and section weights of a plurality of sections of the container and apply the relationship to determine section weights for the plurality of sections of the container.

### PRIORITY

The present application claims the benefit of U.S. Provisional Application Ser. No. 61/415,645, which is incorporated by reference herein in its entirety.

### BACKGROUND

Polyethylene terephthalate (PET) and other types of plastic containers are commonly produced utilizing a machine referred to as a blow molder. The blow molder receives preforms and outputs containers. When a preform is received into a blow molder, it is initially heated and placed into a mold. Hot air is then blown into the preform causing it to stretch and take the shape of the mold. A typical blow molder has between 10 and 24 molds, allowing it to produce multiple containers in parallel. This increases the product rate of the blow molder, but also increases the rate at which defective containers can be generated when there is a problem with one or more blow molding process parameters. Accordingly, container manufacturers are keen to detect and correct blow molding process problems as efficiently as possible.

Various different manual and automated techniques are used to inspect blow-molded containers to detect process problems. Some techniques and equipment focus on preforms upstream of the blow molder, while other inspection techniques focus on containers downstream of the blow molder. Automated systems, such as the PETWALL PROFILER and PETWALL PLUS products, available from AGR INTERNATIONAL, INC. of Butler, Pennsylvania inspect containers downstream of the blow molder. Defective containers are physically ejected from the production line. Systems such as the PROCESS PILOT, also available from AGR INTERNATIONAL can use container measurements from the downstream inspection equipment to control the blow molder and, therefore, correct process problems automatically.

One very common manual technique for downstream container inspection technique involves measuring section weights. To measure the section weights of a container, a systems operator removes the container from the production line either at or downstream of the blow molder. The container is then physically divided into circumferential sections. Each section is individually weighed, yielding a set of section weights. The section weights are subsequently used to set and/or correct blow molding process variables. Because some process variables are mold-specific, meaningful section weight measurements for a blow molder often require measuring (and destroying) at least one container formed by each mold. In a process referred to as a mold round, the blow molder may eject an example container formed by each of its molds. Each container is then cut into sections and the sections weighed, as described above.

Although measuring section weights in a mold round does provide very useful process information, it has several disadvantages as well. First, the process of cutting containers into sections often has a deleterious effect on the resulting measurement. Even when using a rig, it is difficult for the system operator to make identical cuts in multiple containers. Next, the process is destructive. Every mold round requires the destruction of one container for each mold in the blow molder. For a typical blow molder, this requires the destruction of between 10 and 24 containers each time a mold round is taken.

### FIGURES AND APPENDIX

Various embodiments are described herein by way of example in conjunction with the following figures, wherein:

FIG. 1 is simplified block diagram of a blow molder system according to various embodiments;

FIGS. 2, 3 and 11 provide views of a portion of an inspection system according to various embodiments;

FIGS. 4 to 8 show an emitter assembly of the inspection system according to various embodiments;

FIG. 9 shows a sensor of the inspection system according to various embodiments;

FIG. 10 is a simplified block diagram of a sensor circuit board of the inspection system according to various embodiments;

FIG. 12 is a simplified block diagram of a driver board for an emitter assembly 60 of the inspection system according to various embodiments;

FIG. 13 is a timing diagram according to various embodiments;

FIG. 14 is a simplified block diagram of the inspection system according to various embodiments; and

FIG. 15 shows a staggered vertical array of emitter assemblies according to various embodiments.

FIG. 16 is a flow chart showing a one embodiment of process flow for programming the processor to control the blow molder based on real-time container output.

FIG. 17 is chart showing correlation between the base weight and material distribution of ounce PET bottles, according to one embodiment.

FIG. 18 is a diagram of an example container illustrating section weights and measurement techniques.

FIG. 19 is a flow chart showing a process flow, according to one embodiment, for calibrating the processor to generate a model relating material distribution, or another property, to section weights.

Appendix A illustrates slides describing various aspects of the embodiments described herein.

### DESCRIPTION

Various embodiments of the present disclosure are directed to systems and methods for generating section weights for blow molded plastic or PET (polyethylene terephthalate) containers on-line without the need for repeated destruction of containers. According to various embodiments, measurement equipment may be utilized to find the material distribution of a container after its formation (e.g., either in or downstream of the blow molder). For example, an inspection device may be used to take multiple direct or indirect readings of one or more container characteristics across a profile (e.g., a vertical profile) of the container. The container characteristics may comprise, for example, wall thickness (e.g., average 2-wall thickness), mass, volume, etc. A programmable processor may utilize the container characteristics found across the profile of the container to derive a material distribution of the container. In some, but not all, embodiments, the measurements, and therefore the calculated material distribution, need only be taken across the oriented or stretched parts of the container and may exclude non-oriented portions of the container such as, for example, a finish area, a base cup, etc. The processor may derive a relationship between the measured material distribution and the section weights of different sections of the container. To find the section weights of any given container, the processor may be programmed to apply the derived relationship to a measured material distribution.

Container characteristic measurements for generating material distributions may be obtained in any suitable way. For example, in various embodiments, the measurements may be taken utilizing an on-line inspection system comprising a vertical array of emitter assemblies that cyclically emit light energy in at least two different narrow wavelength bands at a blow molded container as the container passes through an inspection area. For example, each emitter assembly may comprise two narrow band light sources: one that emits light energy in a narrow wavelength hand that is substantially absorbed by the material of the container in a manner highly dependent on the thickness of the material; and one that emits light energy in another, discrete narrow wavelength band that is substantially transmissive by the material of the container. The light sources may be LEDs or laser diodes, for example, having different narrow band emission spectra.

According to various embodiments, the inspection system may also comprise a vertical array of broadband photodetectors facing the emitter assemblies, such as in a 1-to-1 relationship. The light energy that is not absorbed by the container may pass through two sidewalls of the container, where the light energy is sensed by the photodetectors. Each broadband photodetector preferably has a broad enough response range to detect light energy from the different light sources of the emitter assemblies. The inspection system may also comprise a processor in communication with the photodetectors, where the processor is programmed to determine a characteristic of the inspected container, such as the average 2-wall thickness of the container or some other characteristic, based on output signals from the photodetectors. For example, the ratio between the detected light energy of the two narrow band light sources may indicate the 2-wall absorption of the container. The processor may utilize this value to generate wall thickness (e.g., average 2-wall thickness), mass, volume, etc., which, based on the profile, may be used to derive the material distribution. As described above, the material distribution may be utilized to generate section weights for the container. The processor may also be programmed to perform other tasks such as, for example, determining which containers should be rejected, determining real time calibration adjustments for the emitters and sensors to maintain calibration, and sending control signals to the blow molder system to adjust parameters of the blow molder, such as heating temperature or other parameters, to close a feedback control loop for the blow molder system.

According to various embodiments, the light sources in the emitter assemblies may be cyclically controlled such that during each cycle there is a time period when: only one of the light sources is on; only the other light source is on; and both light sources are off. Such a timing architecture may aid the processor in determining the characteristics of the container and for calculating the material distribution and section weights. Also, according to various embodiments, pairs of emitters and sensors may be relatively densely spaced along the vertical span of the containers in the inspection area. Thus, a relatively complete material distribution of the inspected container may be obtained. One example of a system such as that described above is set forth in co-pending U.S. Patent Application Publication No. 2009/0278286, filed on Feb. 18, 2009 and incorporated herein by reference in its entirety.

Another type of system that may be used to measure container characteristics for finding material utilizes a broadband light source, a chopper wheel, and a spectrometer to measure the wall thickness of the a container as it passes between the light source and the spectrometer after being formed by a blow molder. The broadband light source in such a system may provide chopped IR light energy that impinges the surface of the plastic container, travels through both walls of the container, and is sensed by the spectrometer to determine absorption levels in the plastic at discrete wavelengths. This information may be used, for example, by a processor, to determine characteristics of the plastic bottle, such as wall thickness, material distribution, etc., and may ultimately be used to determine section weights, as described herein. In practice, such systems may use an incandescent bulb to generate broadband light within the visible and infrared spectrums of interest. The broadband light is chopped, collimated, transmitted through two walls of the plastic container, and finally divided into wavelengths of interest by the spectroscope. An example of such a system is described in U.S. Pat. No. 6,863,860, filed on Mar. 26, 2002, U.S. Pat. No. 7,378,047, filed on Jan. 24, 2005, U.S. Pat. No. 7, 374, 713, filed on Oct. 5, 2006, and U.S. Pat. No. 7,780,898, filed Apr. 21, 2008, all of which are incorporated herein by reference in their entireties.

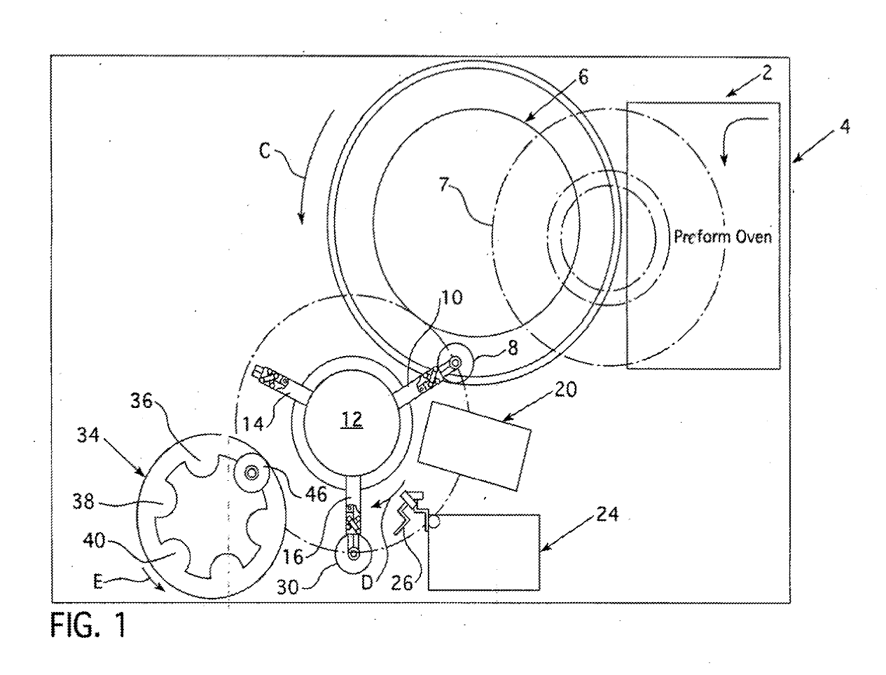

Before describing section weight measurements and calculations in more detail, an overview of a blow molder system is provided, along with an overview of an example inspection system. FIG. 1 is a block diagram of a blow molder system 4 according to various embodiments. The blow molder system 4 includes a preform oven 2 that typically carries the plastic preforms on spindles through the oven section so as to preheat the preforms prior to blow-molding of the containers. The preform oven 2 may comprise, for example, infrared heating lamps or other heating devices to heat the preforms above their glass transition temperature. The preforms leaving the preform oven 2 may enter the blow molder 6 by means, for example, of a conventional transfer system 7 (shown in phantom).

The blow molder 6 may comprise a number of molds, such as on the order of ten to twenty-four, for example, arranged in a circle and rotating in a direction indicated by the arrow C. The preforms may be stretched in the blow molder, using air and/or a core rod, to conform the preform to the shape defined by the mold. Containers emerging from the blow molder 6, such as container 8, may be suspended from a transfer arm 10 on a transfer assembly 12, which is rotating in the direction indicated by arrow D. Similarly, transfer arms 14 and 16 may, as the transfer assembly 12 rotates, pick up the container 8 and transport the container through the inspection area 20, where it may be inspected by the inspection system described below. A reject area 24 has a reject mechanism 26 that may physically remove from the transfer assembly 12 any containers deemed to be rejected.

In the example of FIG. 1, container 30 has passed beyond the reject area 24 and may be picked up in a star wheel mechanism 34, which is rotating in direction E and has a plurality of pockets, such as pockets 36, 38, 40, for example. A container 46 is shown in FIG. 1 as being present in such a star wheel pocket. The containers may then be transferred in a manner known to those skilled in the art to conveyer means according to the desired transport path and nature of the system. According to various embodiments, the blow molder system 4 may produce containers at a rate of 20,000 to 100,000 per hour.

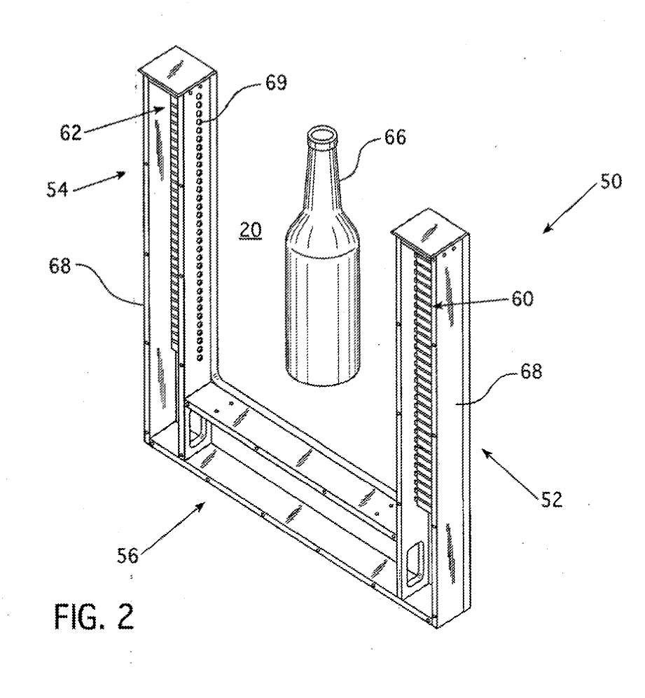

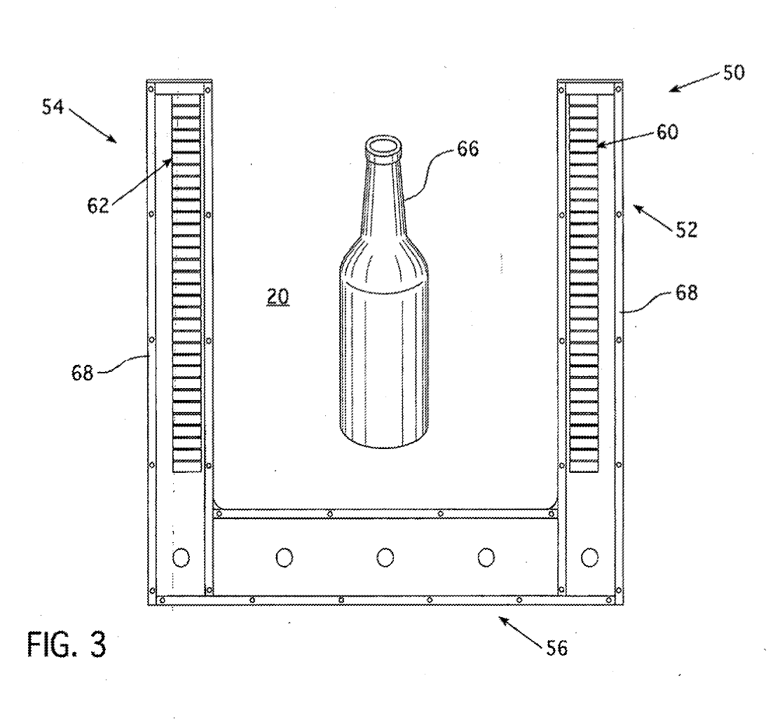

FIGS. 2 and 3 illustrate an inspection system 50 according to various embodiments of the present invention. The inspection system 50, as described further below, may be an in-line inspection system that inspects the containers as they are formed, as fast as they are formed (e.g., up to 100,00 containers per hour), without having to remove the containers from the processing line for inspection and without having to destroy the container for inspection. The inspection system 50 may determine characteristics of each container formed by the blow molder 4 (e.g., average 2-wall thickness, mass, volume, and/or material distribution) as the formed containers are rotated through the inspection area 20 by the transfer assembly 12 following blow molding.

FIG. 2 is a perspective view of the inspection system 50 and FIG. 3 is a front plan view of the inspection system 50. As shown in these figures, the inspection system 50 may comprise two vertical arms 52, 54, with a cross bar section 56 therebetween at the lower portion of the arms 52, 54. One of the arms 52 may comprise a number of light energy emitter assemblies 60, and the other arm 54 may comprise a number of broadband sensors 62 for detecting light energy from the emitter assemblies 60 that passes through a plastic container 66 passing between the arms 52, 54. Thus, light energy. from the emitter assembly 60 that is not absorbed by the container may pass through the two opposite sidewalls of the container 66 and be sensed by the sensors 62. The container 66 may be rotated through the inspection area 20 between the arms 52, 54 by the transfer assembly 12 (see FIG. 1). In other embodiments, a conveyor may be used to transport the containers through the inspection area 20.

According to various embodiments, the emitter assemblies 60 may comprise a pair of light emitting diodes (LEDs) that emit light energy at different, discrete narrow wavelengths bands. For example, one LED in each emitter assembly 60 may emit light energy in a narrow band wavelength range where the absorption characteristics of the material of the container are highly dependent on the thickness of the material of the plastic container 66 (“the absorption wavelength”). The other LED may emit light energy in a narrow band wavelength that is substantially transmissive (“the reference wavelength”) by the material of the plastic container 66.

According to various embodiments, there may be one broadband sensor 62 in the arm 54 for each emitter 60 in the arm 52. Based on the sensed energy at both the absorption and reference wavelengths, the thickness through two walls of the container 66 can be determined at the height level of the emitter-sensor pair. This information can be used in determining whether to reject a container because its walls do not meet specification (e.g., the walls are either too thin or too thick). This information can also be used as feedback for adjusting parameters of the preform oven 2 and/or the blow molder 6 (see FIG. 1) according to various embodiments, as described further below.

The more closely the emitter-sensor pairs are spaced vertically, the more detailed thickness information can be obtained regarding the container 66. According to various embodiments, there may be between three (3) and fifty (50) such emitter-sensor pairs spanning the height of the container 66 from top to bottom. There may be up to thirty two emitter-sensor pairs spaced every 0.5 inches or less, although additional emitter-sensor pairs may be used, depending on the circumstances. Such closely spaced emitter-sensor pairs can effectively provide a rather complete vertical wall thickness profile for the container 66.

According to various embodiments, when the inspection system 50 is used to inspect plastic or PET containers 66, the absorption wavelength narrow band may be around 2350 nm, and the reference wavelength band may be around 1835 nm. Of course, in other embodiments, different wavelength bands may be used. As used herein, the terms “narrow band” or “narrow wavelength band” means a wavelength band that is less than or equal to 200 nm full width at half maximum (FWHM). That is, the difference between the wavelengths at which the emission intensity of one of the light sources is half its maximum intensity is less than or equal to 200 nm. Preferably, the light sources have narrow bands that are 100 nm or less FWHM, and preferably are 50 nm or less FWHM.

The arms 52, 54 may comprise a frame 68 to which the emitter assemblies 60 and sensors 62 are mounted. The frame 68 may be made of any suitable material such as, for example, aluminum. Controllers on circuit boards (not shown) for controlling/powering the emitter 60 and sensors 62 may also be disposed in the open spaces defined by the frame 68. The crossbar section 56 may be made out of the same material as the frame 68 for the arms 52, 54.

The frame 68 may define a number of openings 69 aimed at the inspection area 20. As shown in FIG. 2, there may be an opening for each sensor 62. There may also be a corresponding opening for each emitter assembly 60. Light energy from the emitter assemblies may be directed through their corresponding opening into the inspection area 20 and toward the sensors 62 behind each opening 69.

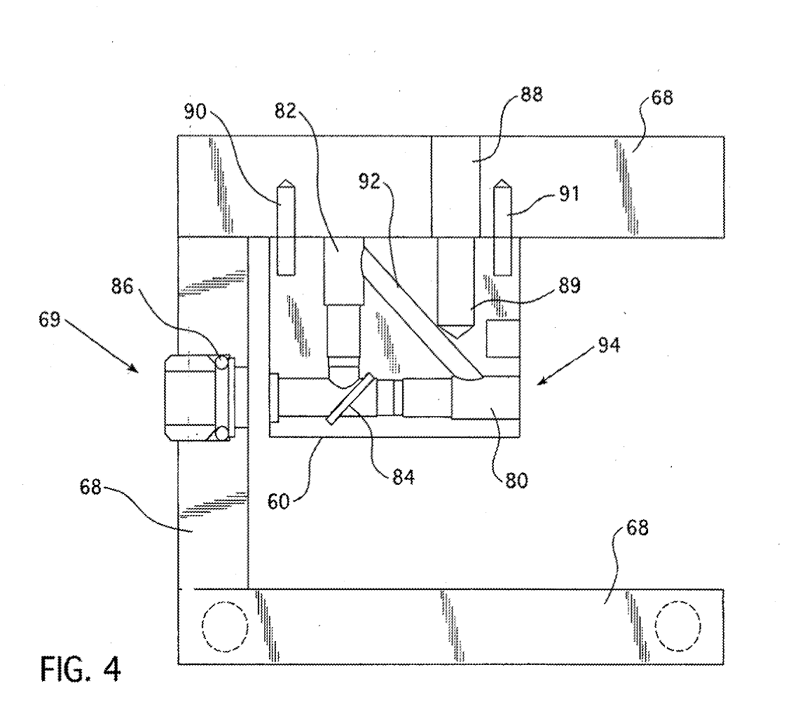

FIG. 4 is a top plan view of an emitter assembly 60 according to various embodiments. The emitter assembly 60 may comprise a first LED contained in a first LED sleeve 80, and a second LED contained in a second LED sleeve 82 (sometimes respectively referred to as “first LED 80” and “second LED 82” for purposes of simplicity). One of the LEDs 80, 82 may emit light energy at the reference wavelength and the other may emit light energy at the absorption wavelength. According to one embodiment, the first LED sleeve 80 may contain the LED emitting at the absorption wavelength band and the second LED sleeve 82 may contain the LED emitting at the reference wavelength band.

As shown in FIG. 4, the emitter assembly 60 may comprise a beam splitter 84. The beam splitter 84 may be a dichroic beam splitter that is substantially transmissive to the light energy from the first LED 80 such that the light energy from the first LED 80 propagates toward the opening 69, and substantially reflective of the light energy from the second LED 82 such that the light energy from the second LED is also directed toward the opening 69. The assembly 60 may also comprise a covering 86 for each opening 69. The covering 86 may be substantially transmissive for the emitted wavelength bands of the first and second LEDs.

A screw (not shown) through screw openings 88, 89 may be used to secure the assembly 60 to the frame 68. Pins (not shown) in pin openings 90, 91 may be used to align the assembly 60 for improved optical performance. Conduit 92 may be used to contain electrical wires for the second LED 82, such that the wires (not shown) for both the first and second LEDs 80, 82 may attach the assembly 60 at a back portion 94 of the assembly 60.

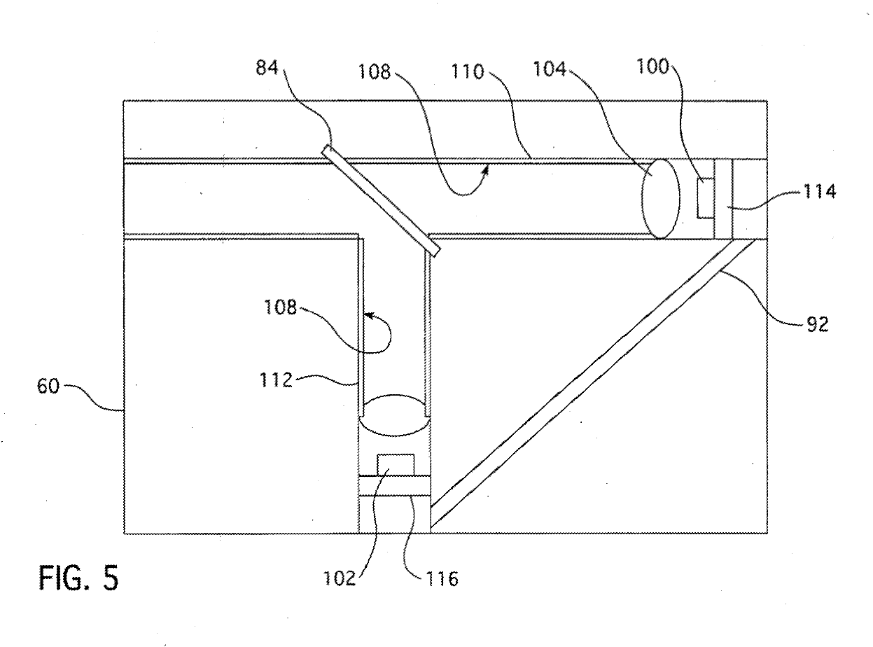

FIG. 5 provides another view of an emitter assembly 60. This figure shows the first LED 100 and the second LED 102. The light energy from each LED 100, 102 may be directed through a one or series of collection and collimating lenses 104, 106, respectively, by highly reflective interior walls 108 of a cylinder casing 110, 112 that respectively encases the LEDs and the lenses. Each LED 100, 102 may have an associated circuit board 114, 116 or other type of substrate to which the LEDs 100, 102 are mounted and which provide an interface for the electrical connections (not shown) to the LEDs 100, 102.

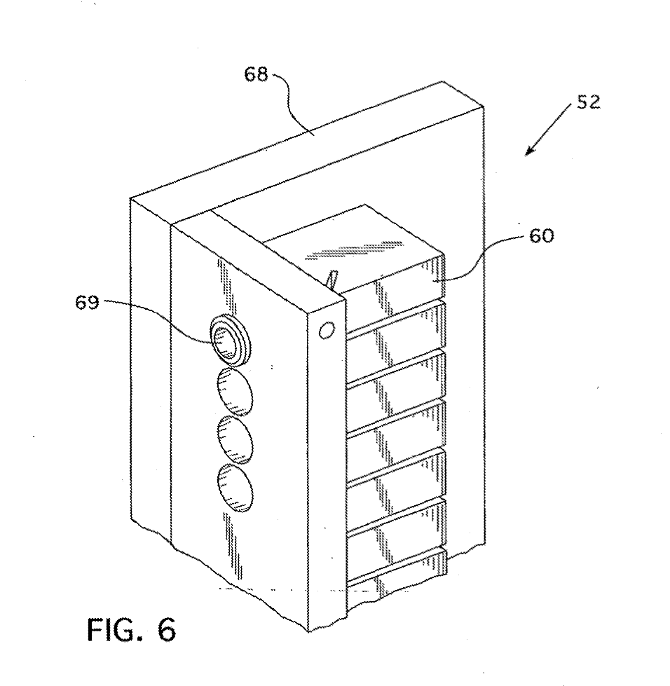

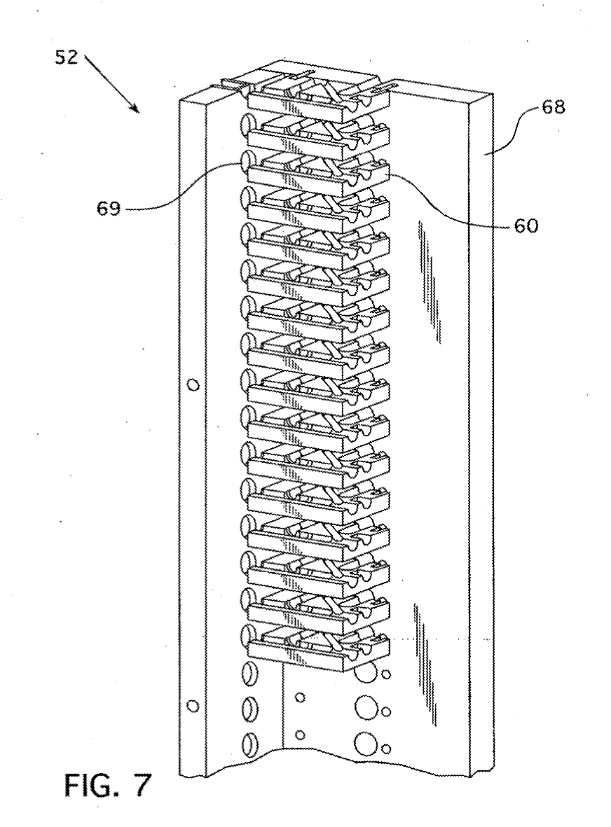

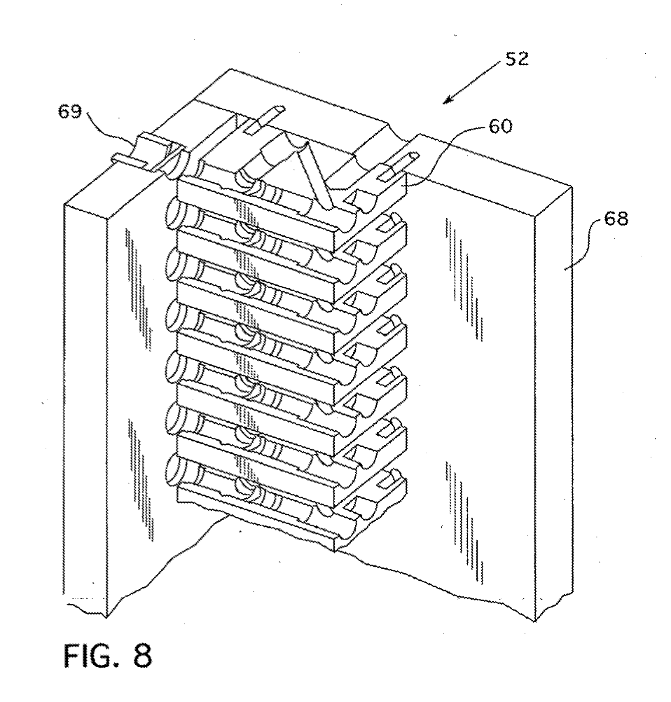

FIGS. 6-8 show different views of the emitter assemblies 60 according to various embodiments. In FIGS. 7 and 8, only half (the lower half) of the emitter assemblies 60 are shown for illustration purposes.

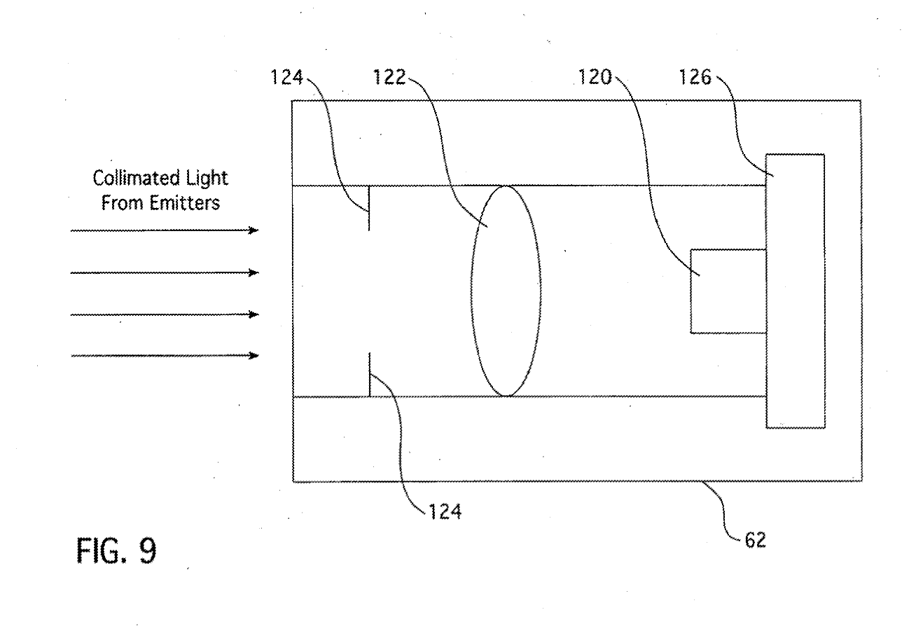

FIG. 9 is a diagram of a sensor 62 according to various embodiments. In the illustrated embodiment, the sensor 62 includes a broadband photodetector 120 for sensing the light energy from the emitter assemblies 60. According to various embodiments, the photodetector 120 may be an enhanced InGaAs photodetector. Such a photodetector is capable of sensing a broad range of wavelengths, including the wavelength bands emitted by the emitter assemblies 60. The sensor 62 may further comprise one or more lenses 122 for focusing the incoming light onto the photodetector 120. The detector may also comprise stray light baffles 124. Also, the photodetector 120 may have an associated circuit board 126 or other type of substrate to which photodetector 120 is mounted and which provides an interface for the electrical connections (not shown) to the photodetector 120.

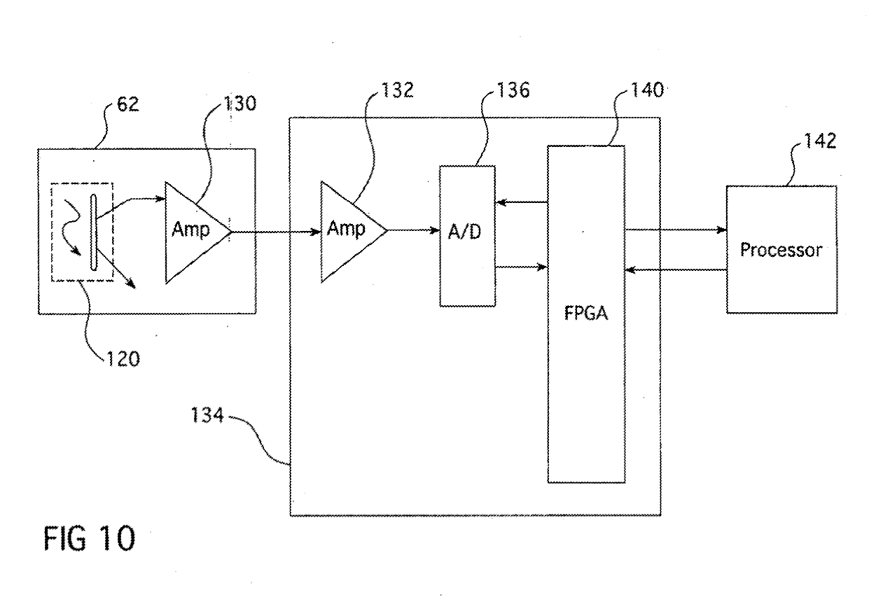

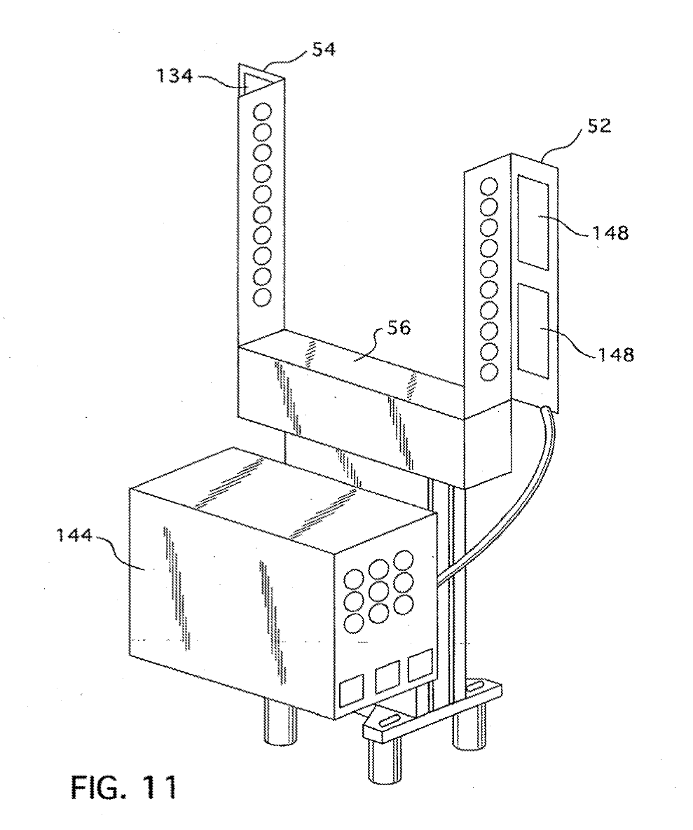

FIG. 10 is a simplified block diagram of the sensor 62 and an associated sensor controller circuit board 134. As shown in FIG. 10, the sensor 62 may further comprise a first amplifier 130 for amplifying the signal from the photodetector 120. The amplifier 130 may be integrated with the photodetector 120 or on the controller circuit board 126 (see FIG. 9). The output of the amplifier 130 may then be input to another amplifier 132 on the sensor circuit board 134. The sensor circuit board 134 may be located near the sensor 62, such as in the open space in the arm 54, as shown in FIG. 11. According to various embodiments, each circuit board 134 may interface with eight sensors 62 so that, for an embodiment having thirty two emitter-sensor pairs, there may be four such sensor circuit boards 134 for the thirty-two sensors.

As shown in FIG. 10, the circuit board 134 may comprise an analog-to-digital (A/D) converter 136 for converting the amplified analog signals from the photodetector 120 to digital form. According to various embodiments, the A/D converter 136 may be a 16-bit A/D converter. The output from the A/D converter 136 may be input to a field programmable gate array (FPGA) 140 or some other suitable circuit, such as an ASIC. The circuit board 134 may communicate with a processor 142 via a LVDS (low voltage differential signaling) communication link, for example, or some other suitable connection (e.g., RS-232), using either serial or parallel data transmission. The processor 142 may be a digital signal processor or some other suitable processor for processing the signals from the sensors 62 as described herein. The processor 142 may have a single or multiple cores. One processor 142 may process the data from each of the circuit boards 134, or there may be multiple processors. The processor(s) 142 may be contained, for example, in an electrical enclosure 144 mounted under the crossbar section 68 of the inspection system 50, as shown in FIG. 11.

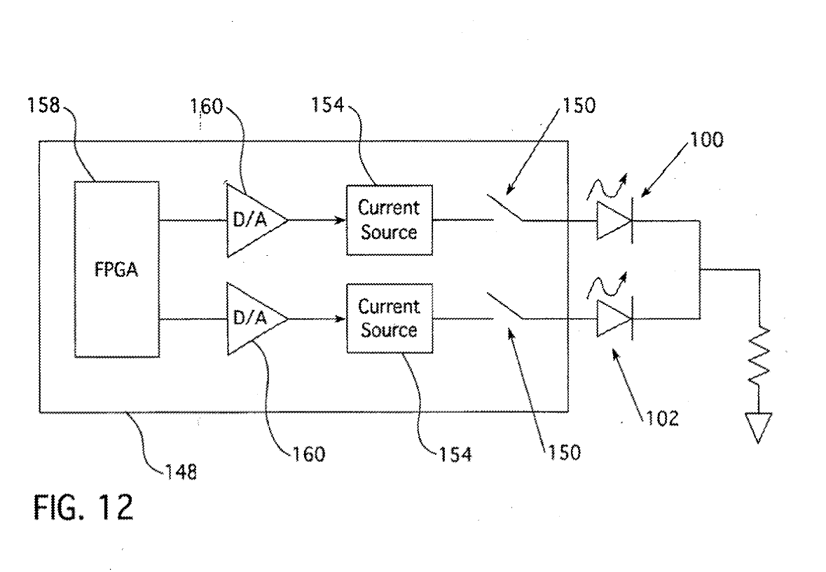

FIG. 12 is a simplified schematic diagram of a controller 148 for the emitter LEDs according to various embodiments. Each LED 100, 102 may have an associated switch 150, which may control when the LEDs are on and off. The switches 150 may be implemented as field effector transistors (FETs), for example. An adjustable constant current source 154 may drive the LEDs 100, 102. The current from the current sources 154 may be adjusted to control the light intensity of the LEDs 100, 102 for calibration purposes, for example. Any suitable adjustable current source may be used, such as a transistor current source or a current mirror. The current sources 154 may be controlled by signals from a FPGA 158 (or some other suitable programmable circuit) via a digital-to-analog (D/A) converter 160. The FPGA 158 may store values to appropriately compensate the intensity levels of the LEDs 100, 102 based on feedback from the processor(s) 142.

According to various embodiments, the FPGA 158 may control the LEDs for numerous emitter assemblies 60. For example, a single FPGA 158 could control eight emitter assemblies 60, each having two LEDs, as described above. The FPGA 158 along with the D/A converter 160, current sources 154, and switches 150 for each of the eight channels could be contained on a circuit board near the emitter assemblies 60, such as in the space defined by the frame 68 of the arm 52, as shown in FIG. 11. For an embodiment having thirty-two emitter assemblies 60, therefore, there could he four such controller circuit boards 148. The FPGAs 158 may communicate with the processor 142 in the enclosure (see FIG. 11) using a LVDS connection or some other suitable serial or parallel communication link.

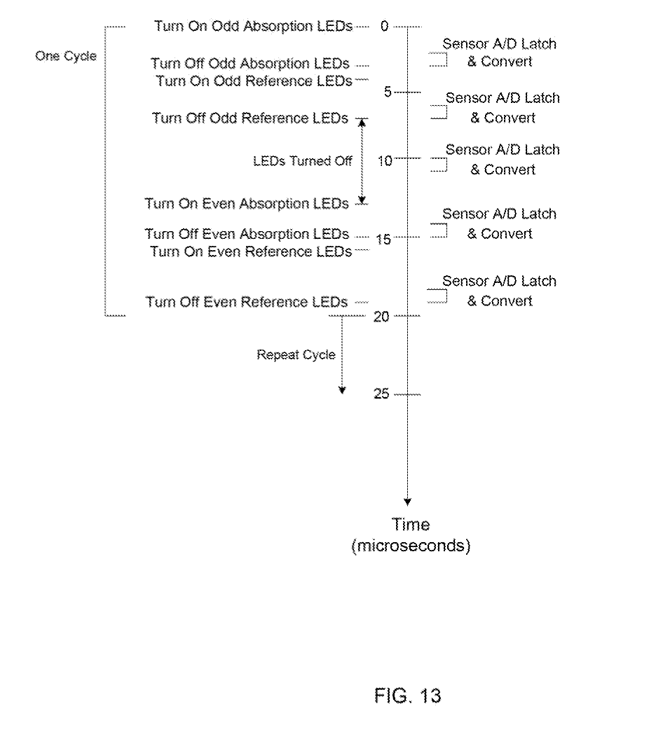

According to various embodiments, the LEDs 100, 102 may be switched on and off cyclically. During a time period when both LEDs 100, 102 are off, the drive for the LEDs 100, 102 may be adjusted and/or the gain of the amplifiers 130, 132 on the sensor side may be adjusted to compensate for drifts in performance and/or to otherwise keep the emitter-sensor pairs calibrated. FIG. 13 is a timing diagram showing the system timing architecture for a sampling cycle according to various embodiments. In the illustrated embodiment, the switching cycle has a duration of 20 microseconds, corresponding to a sampling rate of 50 kHz. Of course, in other embodiments, switching cycles having different durations could be used.

The LEDs 100, 102 of the emitter assemblies 60 preferably take less than 500 nanoseconds to turn on, and the photodetectors 120 of the sensors preferably have a response time of 500 nanoseconds or less. Further, the recovery time of the photodetectors 120 after turn off is preferably 500 nanoseconds or less. As shown in the example of FIG. 13, at the start of the cycle (t=0), the absorption LED in every other emitter assembly 60 (e.g., the “odd” ones) is turned on. Since the sensors 62 may detect light energy from more than one emitter assembly 60, the emitter assemblies 60 may be turned on and off in banks in such a fashion. In the illustrated embodiment, the emitter assemblies 60 are operated it two banks (odd and even), although in other embodiments the emitter assemblies could be operated in more than two banks.

During the approximate time interval from t=2 to 3 microseconds, the A/D converter 136 (see FIG. 10) for each sensor 62 may latch and convert the signal from the photodetector 120 for this condition (the odd absorption LEDs being on). At t=3 microseconds, the odd LEDs may be turned off, and at t=4 microseconds the odd reference LEDs may be turned on. During the approximate time interval from t=6 to 7 microseconds, the A/D converter 136 for each sensor 62 may latch and convert the signal from the photodetector 120 for the condition when the odd reference LEDs are on. At t=7 microseconds, the odd reference LEDs may then be turned off.

From t=7 microsecond to t=12 microsecond, all of the LEDs of the emitter assemblies may be turned off. During the approximate time interval from t=10 to 11 microseconds, the A/D converter 136 for each sensor 62 may latch and convert the signal from the photodetector 120 for the condition when the all of the LEDs are off. At time t=12 microseconds, the “even” absorption LEDs (i.e., the ones that were not turned on at t=0 microseconds) are turned on. During the approximate time interval from t=14 to 15 microseconds, the A/D converter 136 for each sensor 62 may latch and convert the signal from the photodetector 120 for the condition when the even absorption LEDs are on. At t=15 microseconds the even absorption LEDs are turned off, and at t=16 microseconds the even reference LEDs are turned on. During the approximate time interval from t=18 to 19 microseconds, the A/D converter 136 for each sensor 62 may latch and convert the signal from the photodetector 120 for the condition when the even reference LEDs are on. At t=19 microseconds, the even reference LEDs are turned off. The cycle may then be repeated starting at t=20 microseconds, and so on.

According to various embodiments where a blow molder system (such as blow molder system 4 of FIG. 1) is used to fabricate the plastic containers, multiple sensors that are within or operatively associated with the blow molder system may provide information to a processor (such as processor 142) to enable synchronization of the specific molds and spindles in the blow molder which made the container being inspected and thereby provide valuable feedback information. One sensor, designated the blow-molder machine step sensor, may emit a signal which contains information regarding the counting of the molds and spindles from their corresponding starting position. The total number of molds or spindles may vary depending upon the make and model of blow-molder, but this information is known in advance. This information may be programmed into the system. A second signal, which is from the blow-molder synchronization sensor, may provide information regarding start of a new cycle of rotating the mold assembly. The blow-molder spindle synchronizing sensor provides output regarding the new cycle of rotating the spindle assembly. The sensors employed for monitoring machine step mold sync and spindle sync may be positioned at any suitable location within the blow-molder and may be of any suitable type, such as inductive sensors which are well known to those skilled in the art.

A part-in-place sensor may provide a signal to the processor(s) 142 indicating that a container has arrived at the inspection system 20 and that the light-energy-based inspection should be initiated. At that point, the container transects the beams of emitted light from the multiple discrete-wavelength spectral light sources 60. The processor(s) 142 is in communication with the broadband sensors 62 and receives electrical signals from the sensors 62, as described above, in order to perform a comparison of the thickness information contained within the electrical signals with stored information regarding desired thickness. More details regarding such sensors are described in U.S. Pat. No. 6,863,860, which is incorporated herein by reference.

According to various embodiments, if the thickness, or other container attribute, is not within the desired range, the processor(s) 142 may emits a signal or command to a blow-molder reject mechanism 26, which in turn initiates a rejection signal to operate a container rejection system and discard that container from the conveyer.

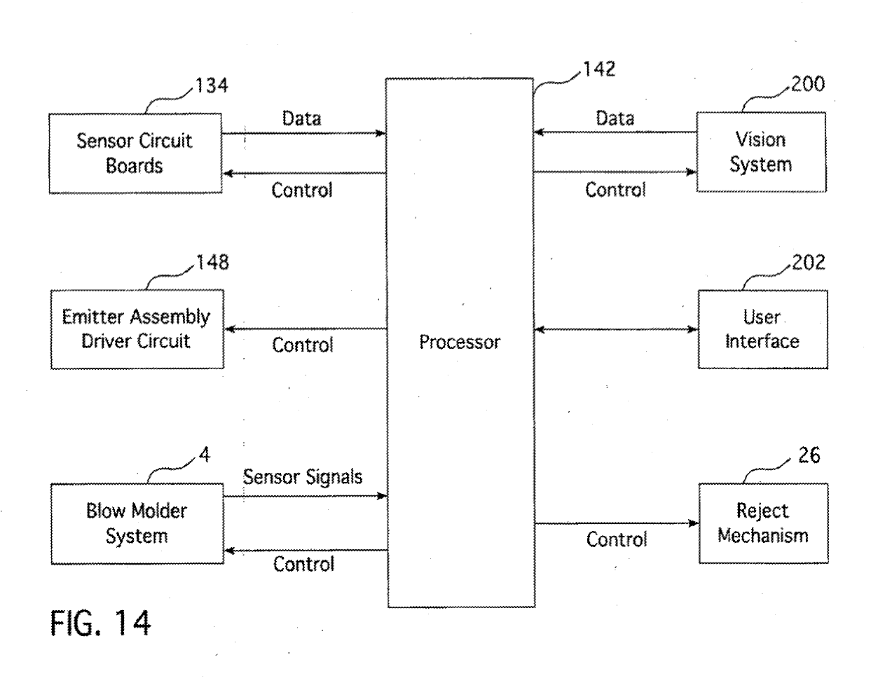

FIG. 14 is a diagram illustrating the processor-based control system that may be realized using the inspection system 50 according to various embodiments. The signals from the photodetectors 120/sensor circuit boards 134 may be input to the processor 142, including the signals for the conditions when only the absorption LEDs are on, when only the reference LEDs are on, and when all of the LEDs are off. Based on this information, the processor 142 can compute or determine the average thickness through 2 sidewalls of the container 66 at each height level of the emitter-sensor pairs. Thus, for example, if there are thirty-two emitter-sensor pairs, the processor 142 can compute the average thickness through 2 sidewalls of the container 66 at thirty-two different height levels on the bottle. This information can be used to determine if a container should be rejected. If a container is to be rejected, the processor 142 may be programmed to send a reject signal to the reject mechanism to the cause the container to be rejected.

The processor 142 may also compute the mass, volume and/or material distribution of the container as these attributes (or characteristics) are related to thickness. The mass or volume of various sections of the inspected container, e.g., sections corresponding to the various height levels of the emitter-sensor pair, could also be calculated by the processor 142. The processor could also compute container diameter by measuring the time between detection of the leading edge of the container and detection of the trailing edge. This time interval, when combined with container velocity information, provides an indication of container diameter at multiple elevations, sufficient for identification of malformed containers.

The processor 142 may be programmed to also calculate trending information, such as the average thickness at each height level for the last x containers and/or the last y seconds. Also, other relevant, related statistical information (e.g., standard deviation, etc.) could be calculated. Based on this information, the processor 142 may be programmed to, for example, send a control signal to the preform oven 2 to modify the temperature of its heaters (e.g., raise or lower the temperature).

The processor 142 may be programmed to also calculate updated calibration data for the emitter assemblies. 60 and the sensors 62 based on the signals from the sensor circuit boards 134. For example, the processor 142 may be programmed to compute whether the drive signal from the current sources 154 for the emitter assemblies 60 must be adjusted and/or whether the gain of either of the amplifier stages 130, 132 of the sensor circuit board 134 must be adjusted. The processor 142 may be programmed to transmit the calibration adjustment signals to one or more of the FPGAs 158 of the driver boards 148 for the emitter assemblies 60 and, based on calibration values coded into the FPGAs 158, the FPGAs 158 may control the drive signal from the current source 154. Similarly, the processor may transmit calibration adjustment signals to the FPGAs 140 of the sensor circuit boards 134 and, based on calibration values coded into the FPGAs 140, the FPGAs 140 may control the gain of the amplifier stages 130, 132 to maintain calibration.

Also, based on the mold-spindle timing sensor information from the blow molder 6, as described above, the processor 142 could calculate the average thickness at each height level for the last x containers for a specified mold, spindle, and/or mold-spindle combination. The processor 142 could also calculate other related statistical information that may be relevant. This information may be used to detect a defective mold or spindle, or to adjust a parameter of the blow molder 6.

The system may also include, in some embodiments, a vision system 200 for inspecting the formed containers. The vision system 200 may comprise one or more cameras to capture images of the formed containers either from the top, bottom, and/or sides. These images may he passed to the processor 142 and analyzed to detect defects in the formed containers. If a container with defects is detected, the processor 142 may be programmed to send a signal to the reject mechanism to reject the container. The vision system could be similar to the vision system used in the AGR TopWave PetWall Plus thickness monitoring system or as described in U.S. Pat. No. 6,967,716, which is incorporated herein by reference.

The output thickness information from the processor(s) 142, as well as the vision-based information for a system that includes a vision system 200, may be delivered to a graphical user interface 202, such as a touch screen display. The GUI 202 may provide an operator with information regarding specific containers produced by particular mold and spindle combinations of the blow molder. It is preferred that the values be averaged over a period of time, such as a number of seconds or minutes. In addition or in lieu of time measurement, the average may be obtained for a fixed number of containers which may be on the order of 2 to 2500. The GUI 202 may also provide trend information for the blow-molder and individual molds and spindles. In the event of serious problems requiring immediate attention, visual and/or audio alarms may be provided. In addition, the operator may input certain information to the processor 142 via the GUI 202 to alter calibrations in order to control operation of the processor(s). Also, the operator may input process limits and reject limits into the processor(s) 142 for each of the thickness measurement zones of the containers to be inspected. The reject limits are the upper and lower thickness values that would trigger the rejection of a container. The process limits are the upper and lower values for the time-averaged or number of container averaged thickness that would trigger a process alarm indicator.

According to various embodiments, in addition to or in lieu of LEDs, the light emitter assemblies 60 may use one or more laser diodes to emit light energy at the discrete wavelength bands. Also, instead of a dichroic beam splitter 84 in the emitter assemblies 60 to merge the discrete narrow band light sources, other optical techniques could be used to achieve the same effect. For instance, a bifurcated fiber optic coupler may used to mix the light energy from the two discrete light sources.

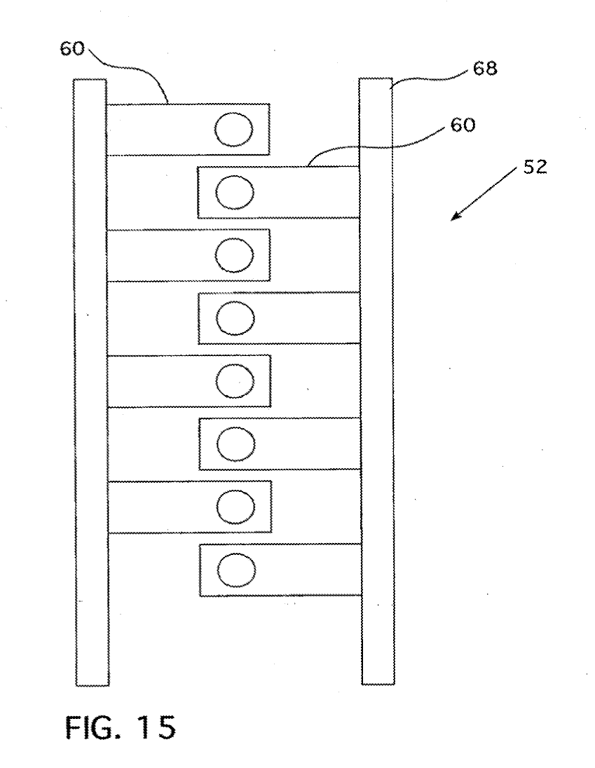

Although the preferred embodiment uses enhanced InGaAs photodetectors 120, in other embodiments other types of detectors could be used to the same effect. For instance, PbS detectors could be used to measure a broad range of light in the relevant wavelength ranges. In addition, although the above-described embodiments use vertically aligned LEDs and sensors, an alternative configuration would stagger the mounting of adjacent LEDs/sensor pairs in order to achieve a more densely stacked vertical array of sensors, as shown in the example of FIG. 15, which just shows a staggered vertical array of emitter assemblies 60. In various embodiments, the photodetectors could be similarly staggered.

According to various embodiments, the processor 142 may be programmed to control input parameters of the blow molder 4 based on measured characteristics of containers generated by the blow molder 4. According to various embodiments, changes to blow molder input parameters may be determined based on the material distribution of output bottles. For example, it has been discovered that there is a high degree of correlation between the material distribution of a container and the parameters of the blow molder that generated it. That is, the material distribution of a bottle may be used to approximate to a high degree of certainty the blow molder conditions under which the bottle was made (e.g., oven lamp temperature, pre-blow pressure, pre-blow timing, etc.). For example, in some embodiments, the R² correlation between material distribution and various blow molder input parameters may be about equal to or greater than 90%. It will be appreciated that similarly high degrees of correlation may exist between blow molder system input parameters and other measured bottle characteristics, such as mass or thickness distribution. Although the model described below is derived in terms of material distribution, various other suitable container properties may be used in additional to or instead of material distribution.

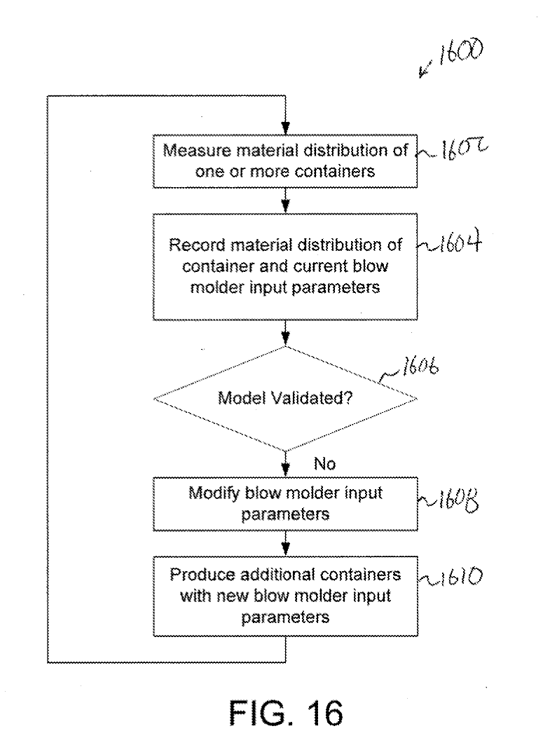

In some embodiments, the relationship between container material distribution and blow molder input parameters may be exploited to program the processor 142 to provide appropriate control signals to the blow molder 4 based on real-time container output. FIG. 16 is a flow chart showing one embodiment of a process flow 1600 for programming the processor 142 to control the blow molder 4 based on real-time container output. At 1602, the system may take measurements and derive the material distribution of one or more containers, for example, as described herein above. At 1604, the processor 142 may record (e.g., store in memory) the material distribution of each container along with values of the input parameters for the blow molder 4 at the time that each container was produced. These values may be entered into a multi-dimensional matrix that may be used, for example, as described herein below.

At 1606, the processor 142 may validate a model relating blow molder input parameters and material distribution. For example, the processor 142 may utilize the matrix to derive the model of blow molder 4 system parameters versus resulting material distributions. The model may be generated using any suitable technique or techniques. In some embodiments, linear regression methods may be utilized. Upon generation, the model may be tested, either against the multi-dimensional matrix itself or against new values captured from newly produced containers. Testing the model may involve finding a correlation between the actual data points of the matrix (or those of newly produced containers) and the data points predicted by the model. The model may be considered validated if the correlation is greater than a predetermined value (e.g., 90%, 95%, 98%, etc.). If the model validates, then it may be used to modify blow molder system 4 parameters in response to produced containers. For example, if the material distribution of produced containers indicates that the containers are approaching a production tolerance, the processor 142 may utilize the model to determine a blow molder system 4 control parameter or parameters that may be modified to move the material distribution of subsequently produced containers away from the production tolerance.

If the model does not validate, the processor 1608 may modify input parameters of the blow molder system 4. In response, the blow molder system 4 may generate additional containers with the new blow molder system input parameters at 1610. The measurement system may measure and/or derive the material distribution of the additional containers at 1602, record (e.g., store in memory) the material distribution and new input parameters at 1604 (e.g., to the multi-dimensional matrix) and determine, again, if the model validates at 1606. This process may be repeated until the model validates, at which point the model may be used to control the blow molder system input parameters, as described above.

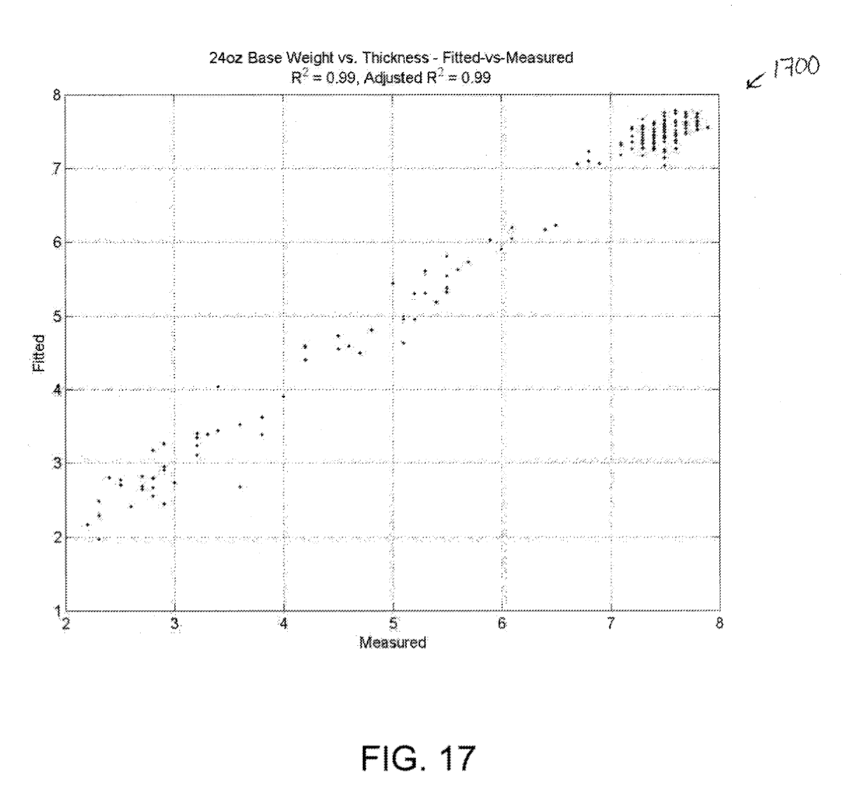

It has additionally been discovered by the inventors that there is a high degree of correlation between the material distribution (or other thickness-related distribution) of a container and the section weights of the container. This means that a model of section weights of different container sections versus material distribution may be generated by creating a matrix relating material distribution to section weights and then generating the model using a suitable technique, such as linear regression. The model may be used, as described herein, to calculate section weights of containers during production based on measurements of material distribution. Accordingly, the need to perform a mold round, and thereby destroy ware, may be obviated. FIG. 17 is chart 1700 showing correlation between the base weight and material distribution of 24 ounce PET bottles, according to one embodiment. The x-axis shows measured based weights, while they-axis shows predicted base weights based on a model generated as described herein. As illustrated, the R² correlation for the measured containers is 99%.

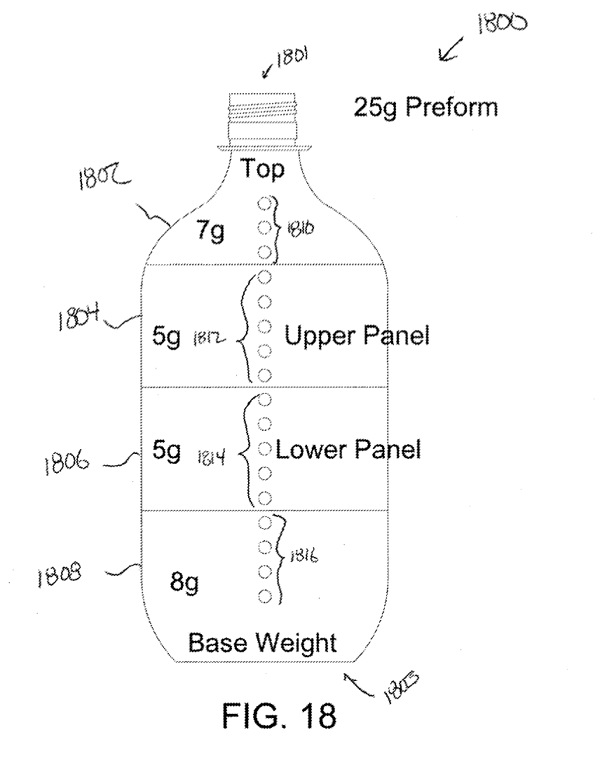

FIG. 18 is a diagram of an example container 1800 illustrating section weights and measurement techniques. The container 1800 comprises a finish 1801 and a base 1803. The finish 1801 may commonly be considered the top of the container 1800 and may be threaded, as shown, for receiving a cap. The base 1803 may commonly be considered the bottom of the container 1800 and can be flat to allow the container 1800 to sit on a flat surface. As illustrated, the container 1800 is divided into four sections, a top section 1802, a high middle section 1804, a low middle section 1806 and a base section 1808. The total weight of the container 1800 is indicated to be 25 grams. It will be appreciated that the total weight of the container 1800 may be about equal to the total weight of the preform from which the container 1800 was formed. Example section weights are also shown in FIG. 18. The top section 1802 is indicated to have a section weight of 7 grams. The high middle section 1804 is indicated to have a section weight of 5 grams, while the base section 1808 is indicated to have a section weight of 8 grams. It will be appreciated that the sum of the section weights may be about equal to the total weight of the container 1800.

Circles 1810, 1812, 1814, 1816 may correspond to points on the container 1800 that are measured by the respective emitter assemblies 60 and sensor assemblies 62. Although the circles 1810, 1812, 1814, 1816 are in a single location in FIG. 18, the respective assemblies may effectively sweep across the container 1800 as it is passed through the inspection system 50. Also, according to various embodiments, it will be appreciated that the circles 1810, 1812, 1814, 1816 may indicate measurements taken on oriented, or stretched portions of the container 1800. Although four sections are shown, it will be appreciated that containers may be divided into more or fewer sections for the purposes of finding section weights.

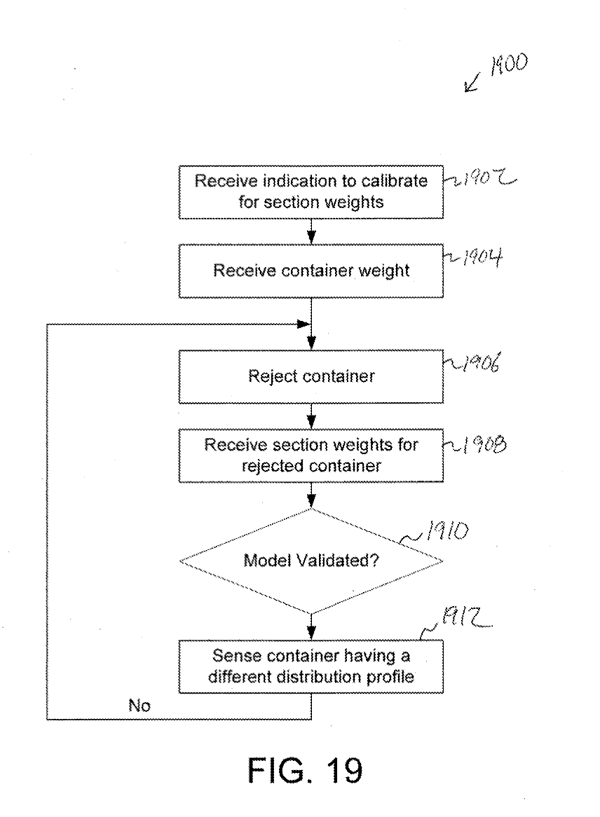

FIG. 19 is a flow chart showing a process flow 1900, according to one embodiment, for calibrating the processor 142 to generate a model relating material distribution, or another property, to section weights. At 1902, the processor 142 may receive an indication to calibrate for section weights. The indication may be received, for example, from a user via the user interface 202. At 1904, the processor 142 may receive a container weight. For example, the container weight may be entered by a user through the user interface 202. The container weight may represent the full weight of the containers to be generated by the blow molder 4. For example, the blow molder 4 may perform batches on performs (and therefore containers) of the same or similar weights. In some embodiments, the user may provide, through the user interface 202, an indication of the division between container sections. For example, the user may be provided with an image of a container similar to the image of the container 1800 shown in FIG. 18. The user may be prompted to graphically or numerically indicate the division between container sections, as well as the number of sections. This information may later be used by the processor 142 in generating the model of section weights versus material distribution. In some embodiments, the processor 142 may generate section weights based on the physical weights of sections provided by the user, as described herein below. This may obviate the need for the user to graphically or numerically indicate the location of divisions between sections, although this information may still be captured and utilized as part of a graphical display of section weights via the user interface 202.

At 1906, the processor 142 may cause a container to be rejected, e.g., by the reject mechanism 26. In some embodiments, the user may be informed ahead of time about the rejection (e.g., via the user interface 202) so that the user may intercept the rejected container. The user may physically cut the rejected container into sections, weigh the sections, and provide the resulting weights to the processor 142 at 1908. In some embodiments, the user may manually enter the resulting section weights via the user interface 202. In other embodiments, the processor 142 may be in communication with a scale or other weighing device. The user may place the separated sections of the rejected container onto the scale, which may automatically communicate its results to the processor 142.

At 1910, the processor 1910 may determine if the measured section weights result in a converging model relating material distribution (or other variable) to the section weights of the measured container or container. For example, the measured material distribution and the measured section weights may be entered into a multidimensional matrix. A suitable statistical method, such as linear regression, may be used to generate a model relating material distribution to section weights. In some embodiments, a single model may be used to model all section weights of the container. In other embodiments, individual models may be generated for each section weight. It will be appreciated that the model may relate material distribution to section weights in any suitable manner. For example, the model may relate results from sensors impinging on a particular section to the weight of that section. For example, sensors corresponding to circles 1810 may be related to the section weight of the top section 1802; sensors corresponding to circles 1812 may be related to the section weight of the high middle section 1804; sensors corresponding to circles 1814 may be related to the section weight of the low middle section 1806 sensors corresponding to circles 1816 may be related to the section weight of the base section 1808. In various embodiments, all sensor readings may be related to each section weight.

The model may be generated according to any suitable modeling method. For example, simple linear regression may be used to relate some or all of the sensor readings to one or all of the section weights. In some embodiments, the processor 142 may be programmed to utilize modeling techniques that focus on input variables showing a high degree of correlation to each section weight. For example, according to a stepwise regression, input variables (e.g., sensor outputs) that do not highly correlate to one or more section weights may be dropped from the model of that weight or weights. Also, in some embodiments, a principle components regression technique may be used to transform the original input variables (e.g., sensor outputs) into new sets of variables that more closely correlate to the desired section weight or weights. It will be appreciated that any suitable modeling technique or techniques may be used.

Upon generation of the model, the processor 142 may validate the model. For example, a correlation may be found between the measured section weights and the section weights as predicted by the model. The correlation may be any suitable statistical measure. In some embodiments, the correlation may be measured by finding an adjusted R² value, or coefficient of determination. The adjusted R² value may take into account the number of predictors used (e.g., the number of variables/sensor outputs) as well as the number of data samples (e.g., the number of measured containers). If the correlation is greater than a predetermined value (e.g., the adjusted R² is greater than or equal to 90%, 95%, 98%, etc.), then the model may be considered validated. In some embodiments, the model may not be considered validated until a predetermined number of containers have been considered.

If the model is not validated at 1910, the processor 142 may, at 1912, sense a container having a material distribution (or other variable) that may be different that some or all of the containers previously measured during the section weight calibration process. In some embodiments, the processor 142 may wait until environmental changes and/or parameter drift of the blow molder 4 cause the production of containers having desirable material distributions (or other variables). In other embodiments, the processor 142 may modify the input parameters of the blow molder system 4 to generate containers having desirable material distributions (e.g., material distributions that are underrepresented in the current multidimensional matrix). The newly detected and/or produced containers may be rejected at 1906, measured, and entered into the matrix and considered in the model, as described above. The process may continue until the model validates. It will be appreciated that the section weight calibration process 1900 may be performed in conjunction with the process 1600 for generating a model of blow molder system 4 parameters. For example, the process 1900 may be performed immediately after or during the process 1600. Also, in various embodiments, the model generated by the process 1900 may be saved and re-used for containers having the same container weight and material type. For example, the model may be saved as a job set-up parameter that may be re-accessed (e.g., through the interface 202).

When the model relating material distribution (or another suitable variable) to different section weights is generated, for example, as described above, the processor 142 may use the model to calculate section weights for newly generated containers without taking physical section weights of the containers. This may obviate the need for physical mold rounds and minimize the need to destroy containers in order to obtain section weights. For example, the user interface 202 may comprise a button and/or screen allowing the user to request section weight information for currently or previously produced containers. Also, for example, the processor 142 may store section weights for containers, as they are produced, for different purposes. The section weights for different containers may be organized, stored and/or analyzed in any suitable mariner. For example, section weight averages may be taken by a mold or molds, a spindle or spindles, a combination of one or more mold/spindle combinations, etc. over any suitable time period or number of produced containers.

According to various embodiments, the user interface 202 may be configured to display and/or store data equivalent to a mold round. For example, the interface 202 may comprise a software or hardware button allowing the user to request mold round information. In response to activation of the button, the processor 142 may compile section weight information corresponding all or fewer than all of the molds of the blow molder system 4. This information may be stored for later use and/or displayed to the user. The section weight information for each mold may comprise any suitable information. For example the section weight information for each mold may comprise a section weight of the last measured container produced by each mold and/or an average or other compilation of sections weights of containers produced by each mold over a given time period and/or number of containers.

The examples presented herein are intended to illustrate potential and specific implementations of the embodiments. It can be appreciated that the exemplary embodiments are intended primarily for purposes of illustration for those skilled in the art. No particular aspect or aspects of the examples is/are intended to limit the scope of the described embodiments.

As used in the claims, the term “plastic container(s)” means any type of container made from any type of plastic material including polyvinyl chloride, polyethylene, polymethyl methacrylate, polyurethanes, thermoplastic, elastomer, PET, or polyolefin, unless otherwise specifically noted.

It is to be understood that the figures and descriptions of the embodiments have been simplified to illustrate elements that are relevant for a clear understanding of the embodiments, while eliminating, for purposes of clarity, other elements. For example, certain operating system details and power supply-related components are not described herein. Those of ordinary skill in the art will recognize, however, that these and other elements may be desirable in inspection systems as described hereinabove. However, because such elements are well known in the art and because they do not facilitate a better understanding of the embodiments, a discussion of such elements is not provided herein.

In general, it will be apparent to one of ordinary skill in the art that at least some of the embodiments described herein may be implemented in many different embodiments of software, firmware and/or hardware. The software and firmware code may be executed by a processor (such as the processor 142) or any other similar computing device. The software code or specialized control hardware which may be used to implement embodiments is not limiting. The processors and other programmable components disclosed herein may include memory for storing certain software applications used in obtaining, processing and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component, to perform a given function or functions. Except where such substitution would not be operative, such substitution is within the intended scope of the embodiments. For example, processor 142 may be replaced with multiple processors.

While various embodiments have been described herein, it should be apparent that various modifications, alterations and adaptations to those embodiments may occur to persons skilled in the art with attainment of at least some of the advantages. The disclosed embodiments are therefore intended to include all such modifications, alterations and adaptations without departing from the scope of the embodiments as set forth herein.

We claim:

1. A computer implemented system for generating section weights for blow-molded containers on-line, the system comprising:
an inspection device programmed to take a plurality of measurements of one or more container characteristics across a profile of a container while the container is on-line;
a programmable processor programmed to:
receive the plurality of measurements;
based on the plurality of measurements, derive a material distribution of the container;
derive a relationship between the measured material distribution and section weights of a plurality of sections of the container;
apply the relationship to determine section weights for the plurality of sections of the container.
